(19) United States
(12) Patent Application Publication
(10) Pub. No.: US 2015/0148211 A1
(43) Pub. Date: May 28, 2015

(54) COMBINED FOLDING ROLLER MODULE

(71) Applicant: CHAN LI MACHINERY CO., LTD., TAOYUAN 333 (TW)

(72) Inventor: TUNG-I TSAI, TAOYUAN 333 (TW)

(21) Appl. No.: 14/297,813

(22) Filed: Jun. 6, 2014

(30) Foreign Application Priority Data
Nov. 28, 2013 (TW) 102143427

(51) Int. Cl. B31F 1/00

(52) U.S. Cl. CPC B31F 1/0006
USPC 493/471

(57) ABSTRACT

A combined folding roller module is disclosed. The combined folding roller module of the present invention comprises a shaft, a plurality of folding wheels and at least one bearing unit. In the present invention, an appropriate quantity of bearing units are used to support the combined folding roller at suitable locations for enhancing the strength of the combined folding roller module, reducing the deformation of the combined folding roller module, and reducing the vibration during operation.

### FIELD OF THE INVENTION

The present invention relates to a folding roller module, and more particularly to a combined folding roller module.

### BACKGROUND OF THE INVENTION

Referring to FIG. 1, there is shown a schematic diagram of a folding apparatus according to the prior art. The folding apparatus comprises a pair of fixed knives 12, a pair of cutting rollers 14, a pair of folding rollers 16, and a pair of folding fingers 18.

In general, the web material 11 is cut by the fixed knives 12 and the cutting rollers 14 into a plurality of sheets of web material with the same size. The sheets of web material are then fed to the pair of folding rollers 16 to form folding lines at a predetermined location on the sheets. The pair of folding fingers 18 is adapted to stack the plurality of sheets of web material to form an interfolded web material 13.

The distance between the pair of folding rollers 16 affects the quality of products greatly. If the folding rollers 16 are too close to each other, collisions may occur during operation, so that the web material and the equipment may be damaged. If the folding rollers 16 are too far apart, the folding lines formed will be too faint, and the folding quality of the product will be affected improperly.

In the prior art, a folding roller 16 is supported only by three bearing units. The bearing units are located at both ends and the middle of the folding roller 16. The wider the folding roller is, the greater the deformation and vibration are during operation.

### SUMMARY OF THE PRESENT INVENTION

It is an object of the present invention to provide a folding roller module, and more particularly to a combined folding roller module.

It is another object of the present invention to provide a combined folding roller module for enhancing the strength of the folding roller module.

It is still another object of the present invention to provide a combined folding roller module, wherein the number of the bearing units can be increased for enhancing the strength of the folding roller module and improving the operation stability thereof.

The present invention provides a combined folding roller module, comprising: a shaft; a plurality of folding wheels disposed on the shaft; and at least one bearing unit disposed on the shaft, wherein the at least one bearing unit supports the combined folding roller module at suitable location along the length of the shaft.

In one embodiment of the present invention, each of the folding wheels comprises a plurality of ridges and a plurality of grooves disposed on the circumference of the folding wheel alternately in spaced apart relation.

In one embodiment of the present invention, a plurality of suction holes are disposed around the ridges and the grooves of each of the folding wheels.

In one embodiment of the present invention, the shaft comprises a plurality of suction channels and a plurality of openings, wherein each of the suction channels is disposed parallel to a rotation axis of the shaft, each of the openings is disposed on a circumference of the shaft and is connected between one of the suction channels and one of the suction holes.

In one embodiment of the present invention, each of the suction holes has a larger diameter at an inner circumference of the folding wheel and a smaller diameter at an outer circumference of the folding wheel.

In one embodiment of the present invention, each of the openings has a diameter larger than or equal to the diameter of the suction hole.

In one embodiment of the present invention, each of the folding wheels comprises a plurality of tapped holes and is fastened to the shaft by bolts respectively.

In one embodiment of the present invention, each of the bearing unit comprises a frame and a bearing.

### BRIEF DESCRIPTION OF THE DRAWINGS

FIG. 1 is schematic diagram of a folding apparatus according to the prior art.

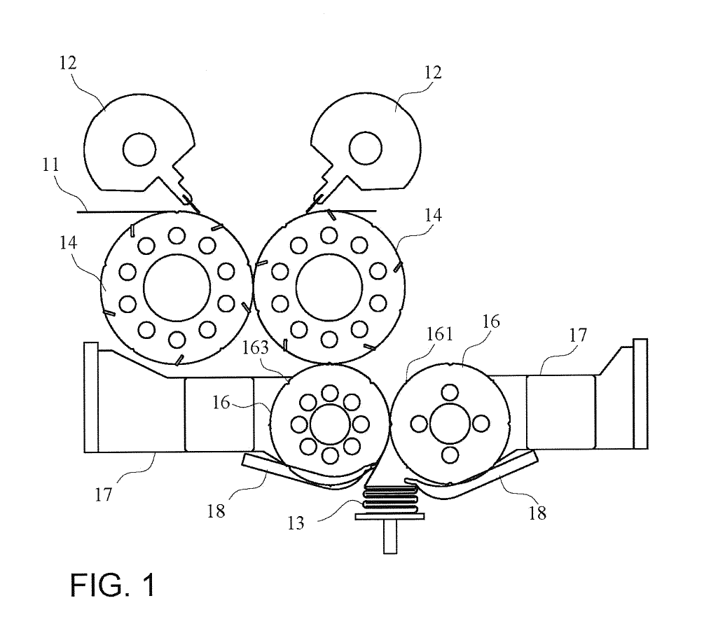

FIG. 2 is a schematic diagram of a combined folding roller module in accordance with one embodiment of the present invention.

FIG. 3 is a schematic enlarged partial view of the combined folding roller module in accordance with the embodiment shown in FIG. 2.

FIG. 4 is a sectional view of the combined folding roller module in accordance with the embodiment shown in FIG. 2.

FIG. 5 is an enlarged partial view of the combined folding roller module in accordance with the embodiment shown in FIG. 2.

### DETAILED DESCRIPTION OF THE PREFERRED EMBODIMENTS

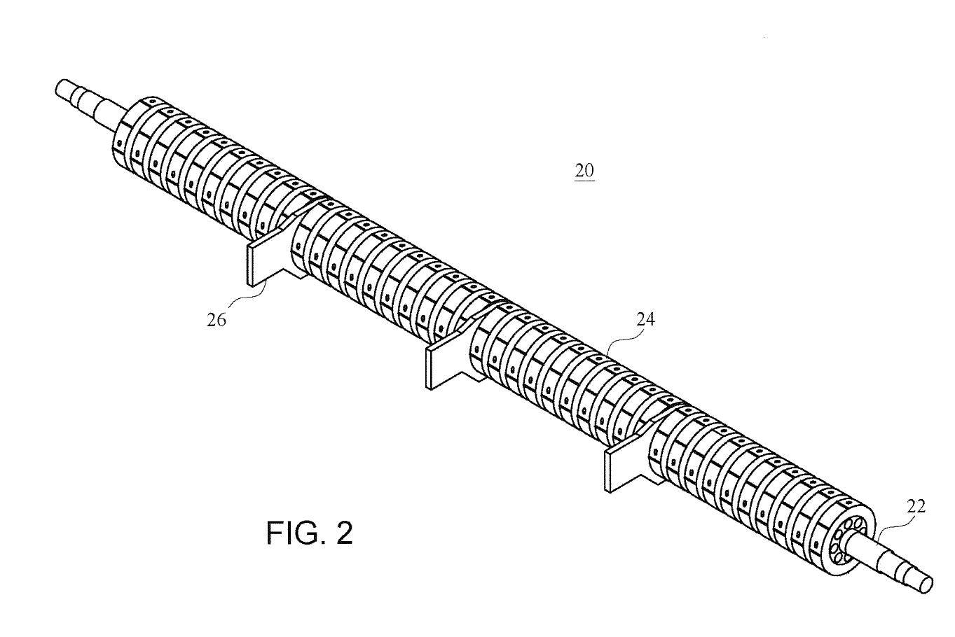

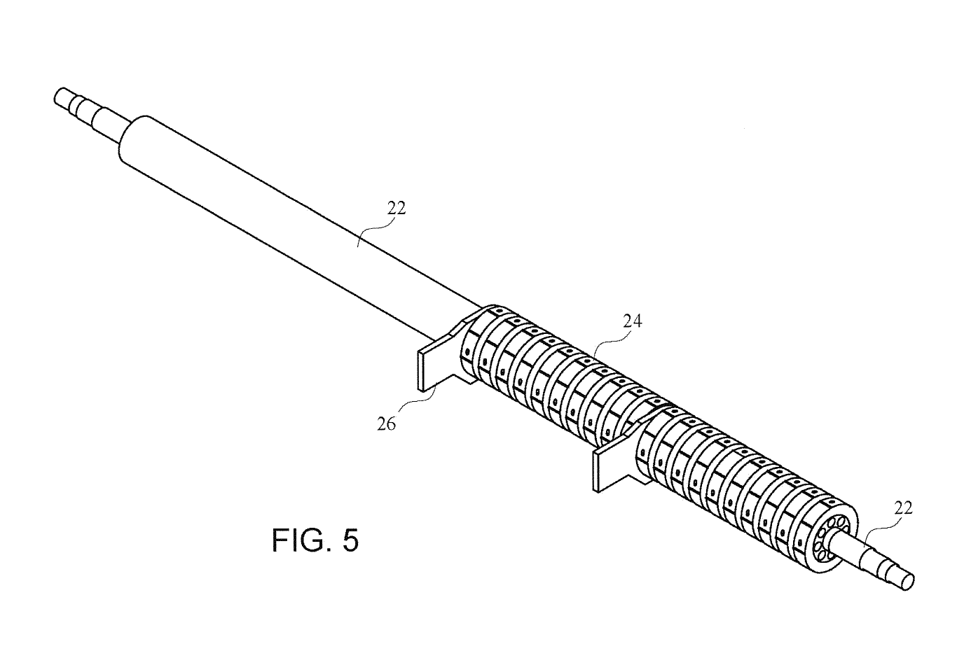

Referring to FIGS. 2-5, a schematic diagram, schematic enlarged partial view, a sectional view, and an enlarged partial view of a combined folding roller module in accordance with one embodiment of the present invention are illustrated. The combined folding roller module 20 comprises a shaft 22, a plurality of folding wheels 24 and at least one bearing unit 26.

The plurality of folding wheels 24 are disposed on the shaft 22. The bearing unit 26 is disposed on the shaft 22 and supports the combined folding roller module 20 at suitable location along the length of the shaft 22 for enhancing the strength of the combined folding roller module 20, thereby reducing deformation and reducing vibration of the combined folding roller module 20 during operation. The quantity and location of the bearing unit 26 are determined by the length of the shaft 22.

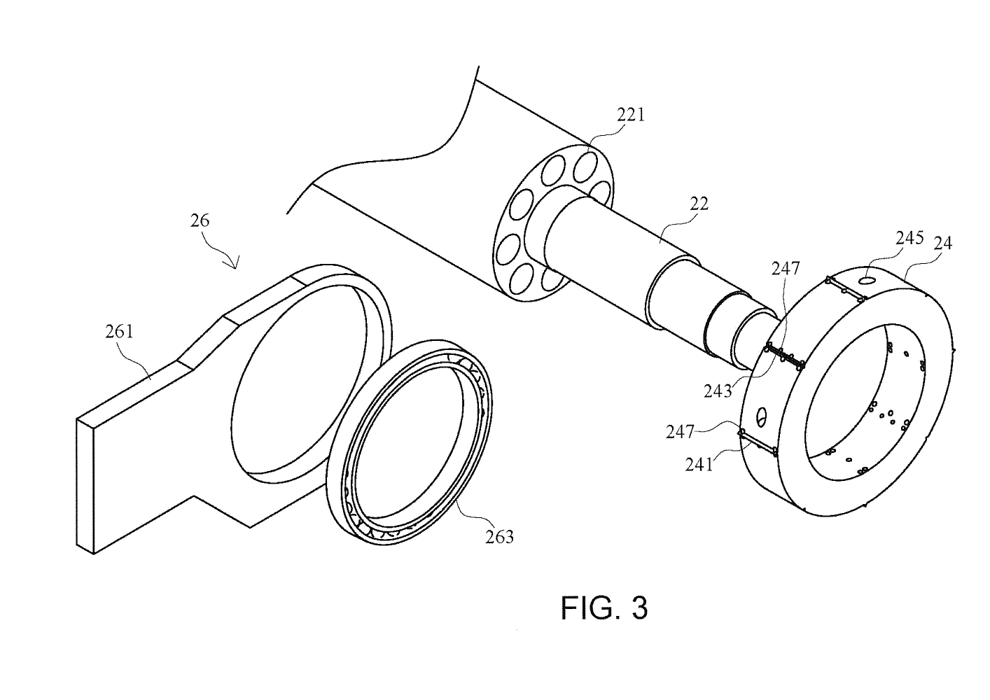

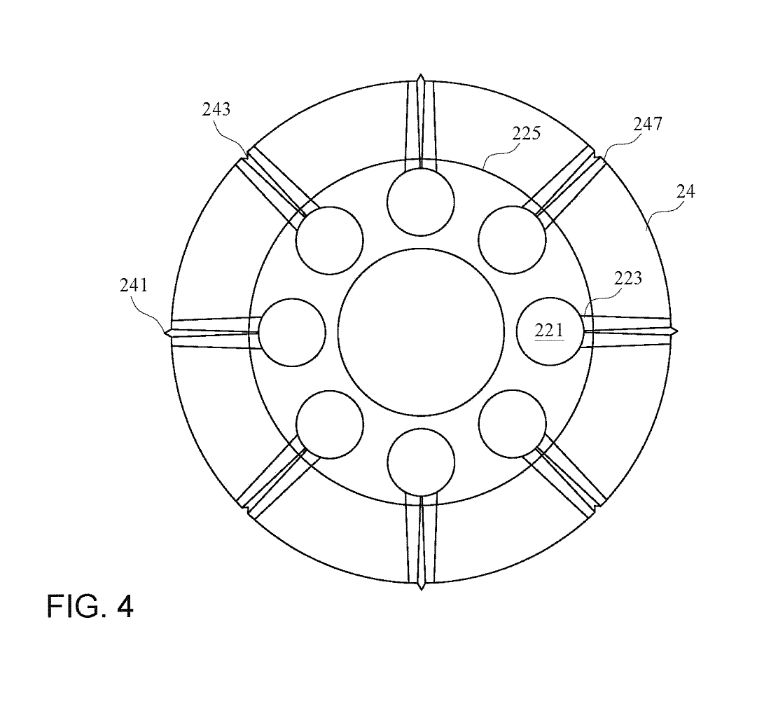

In one embodiment of the present invention, each of the folding wheels 24 comprises a plurality of ridges 241 and a plurality of grooves 243 disposed at spaced intervals around the circumference of the folding wheel 24. In the illustrated embodiment, the folding wheel 24 have a series of alternating ridges 241 and grooves 243 disposed around the circumference of the folding wheel 24. As shown in FIGS. 3-4, the ridges 241 or grooves 243 may have a generally V-shaped cross-section.

In one embodiment of the present invention, respective sets of suction holes 247 are associated with the ridges 241 and grooves 243. The sets of suction holes 247 may comprise a plurality of suction holes 247 disposed on each side of the respective ridge 241 and groove 243. The web material may be sucked and held against the surface of the folding wheel 223 by suction provide via the suction holes 247.

In one embodiment of the present invention, the shaft 22 comprises a plurality of suction channels 221 and a plurality of openings 223. Each of the suction channels 221 is disposed parallel to the rotation axis (or along the length) of the shaft 22 and is connected to a suction apparatus (not shown). Each of the openings is disposed on the circumference 225 of the shaft 22 and is connected to one of the suction channels 221. Each of the openings is also associated and connected with a suction hole 247 of a folding wheel 24.

In one embodiment of the present invention, each of the suction holes 247 has a larger diameter at the inner circumference of the folding wheel 24 and a smaller diameter at the outer circumference of the folding wheel 24. The opening 223 of the shaft 22 has a diameter larger than or equal to the diameter of the suction hole 247 at the inner circumference of the folding wheel 24. The structure of the suction hole 247 of the present embodiment prevents the suction hole 247 from being stuck.

In one embodiment of the present invention, a plurality of tapped holes 245 are provided in each of the folding wheels 24. The folding wheels 24 are fastened to the shaft 22 by bolts (not shown).

In one embodiment of the present invention, each of the bearing unit 26 comprises a frame 261 and a bearing 263. By using a suitable quantity of bearing units 26 at suitable locations along the length of the shaft 22, the strength of the combined folding roller module 20 is improved.

A combined folding roller module 20 according to the illustrated embodiment has a suitable quantity of bearing units 26 that can support the combined folding roller module 20 at suitable locations for enhancing the strength of the combined folding roller module 20, thereby reducing deformation of the combined folding roller module 20 under load and reducing vibration during operation.

Although particular embodiments of the invention have been described in detail for purposes of illustration, various modifications and enhancements may be made without departing from the scope of the invention specified by the claims.

What is claimed is:

1. A combined folding roller module, comprising:
a shaft;
a plurality of folding wheels disposed on the shaft; and
at least one bearing unit disposed on the shaft;
wherein the at least one bearing unit supports the combined folding roller module at suitable location along the length of the shaft.

2. The combined folding roller module as claimed in claim 1, wherein each of the folding wheels comprises a plurality of ridges and a plurality of grooves disposed on the folding wheel alternately in spaced apart relation.

3. The combined folding roller module as claimed in claim 2, wherein a plurality of suction holes are disposed around the ridges and the grooves of each of the folding wheels.

4. The combined folding roller module as claimed in claim 3, wherein the shaft comprises a plurality of suction channels and a plurality of openings, wherein each of the suction channels is disposed parallel to a rotation axis of the shaft, each of the openings is disposed on a circumference of the shaft and is connected between one of the suction channels and one of the suction holes respectively.

5. The combined folding roller module as claimed in claim 4, wherein each of the suction holes has a larger diameter at a inner circumference of the folding wheel and a smaller diameter at an outer circumference of the folding wheel.

6. The combined folding roller module as claimed in claim 5, wherein each of the openings has a diameter larger than or equal to the diameter of the suction hole.

7. The combined folding roller module as claimed in claim 1, wherein each of the folding wheels comprises a plurality of tapped holes for being fastened to the shaft by bolts respectively.

8. The combined folding roller module as claimed in claim 1, wherein each of the bearing unit comprises a frame and a bearing.
